(19) United States
(12) Patent Application Publication
(10) Pub. No.: US 2013/0315398 A1
(43) Pub. Date: Nov. 28, 2013

(54) Audio Device and Audio Signal Inputting and Outputting Method thereof

(71) Applicant: Yao-Hsien Chiu, Taipei City (TW)

(72) Inventor: Yao-Hsien Chiu, Taipei City (TW)

(21) Appl. No.: 13/477,065

(22) Filed: May 22, 2012

(51) Int. Cl. H04R 5/00; H02B 1/00

(52) U.S. Cl. 381/17; 381/123

(57) ABSTRACT

A multiplexer is utilized by the audio device for inputting audio-in signals and outputting audio-out signals at a same connector and for providing an ignorable delay for avoiding spikes introduced at the beginning of generating audio-out signals.

### BACKGROUND

1. Technical Field

The present invention relates to an audio device and an audio signal inputting and outputting method thereof, and more particularly, to an audio device using only one connector for inputting an audio-in signal or outputting an audio-out signal and an audio signal inputting and outputting method implemented on the audio device.

2. Description of the Conventional Art

In a conventional audio player, transmission of audio-in signals is required to be separated from transmission of audio-out signals; therefore, at least two headphone sockets, i.e. earphone jacks, are disposed for respectively inputting the audio-in signals and outputting the audio-out signals. However, utilization of the headphone sockets also results in more elements and printed circuit boards (PCBs) utilized in the conventional audio player, so that a larger cost is introduced in fabricating the conventional audio player.

Please refer to FIG. 1, which illustrates a conventional audio player 100. As shown in FIG. 1, the conventional audio player 100 includes an audio-in connector 110, a path module 130, a micro-processor 140, a path module 150, and an audio-out connector 120. When the audio player 100 is set to record audios, a left audio-in signal AI_L and a right audio-in signal AI_R are inputted at the audio-in connector 110, and then transmitted to the micro-processor 140 via the path module 130 for further processing, such transforming the audio-in signals into digital signals using a codec installed or disposed inside the micro-processor 140.

Then, when the audio player 100 is set to play the previously-recorded audios, i.e., the left audio-in signal AI_L and the right audio-in AI_R, the micro-processor 140 transforms the digital signals into a left audio-out signal AO_L1 and a right audio-out signal AO_R1 using codec using the codec. However, spikes may occur at the beginning of generating the left audio-out signal AO_L1 and the right audio-out signal AO_R1 because of the codec, therefore, the path module 150 includes N-type MOSFETs 160 and 170 for blocking the spikes, and a left audio-out signal AO_L2 and a right audio-out signal AO_R2 are thereby generated with the aid of the N-type MOSFETs 160 and 170 without introducing spikes. At last, both the left audio-out signal AO_L2 and the right audio-out signal AO_R2 are outputted at the audio-out connector 120 for playing audios.

In views of costs, utilization of the audio-in connector 110 and the audio-out connector 120 may introduce redundant costs in hardware, such as PCBs and related elements, because of separation of inputting the audio-in signals and outputting the audio-out signals. Besides, even though the spikes introduced by using the codec can be blocked by using the N-type MOSFETs 160 and 170, utilization of both the N-type MOSFETs 160 and 170 also brings additional costs to the conventional audio player 100.

### SUMMARY

The claimed invention discloses an audio device. The audio device comprises a connector, a micro-processor, a first path module, a second path module, and a multiplexer. The connector is configured to electrically interface with an external device. The micro-processor is configured to selectively process an audio-in signal or to generate an audio-out signal. The first path module is configured to transmit the audio-out signal from the micro-processor. The second path module is configured to transmit the audio-in signal to the micro-processor. The multiplexer is configured to selectively transmit the audio-out signal from the first path module to the connector or transmit the audio-in signal from the connector to the second path module, according to a control signal from the micro-processor.

The claimed invention discloses an audio signal inputting and outputting method for an audio device. The audio device comprises a multiplexer connected to a connector through a two-way path and selectively connected to a micro-processor through a first one-way path or a second one-way path. The method comprises providing a control signal to the multiplexer for enabling a connection between the connector and the micro-processor; and selectively connecting the connector to the micro-processor via the first one-way path or the second one-way path according to the control signal.

The claimed invention further discloses an audio signal inputting and outputting method for an audio device. The audio device comprises a two-way path for connecting a connector to a multiplexer, a first one-way path and a second one-way path. The first one-way path and the second one-way path are utilized for connecting a micro-processor to the multiplexer. The method comprises providing a control signal from the micro-processor to the multiplexer; and switching a connection of the two-way path from the first one-way path to the second one-way path by the multiplexer according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional audio player.

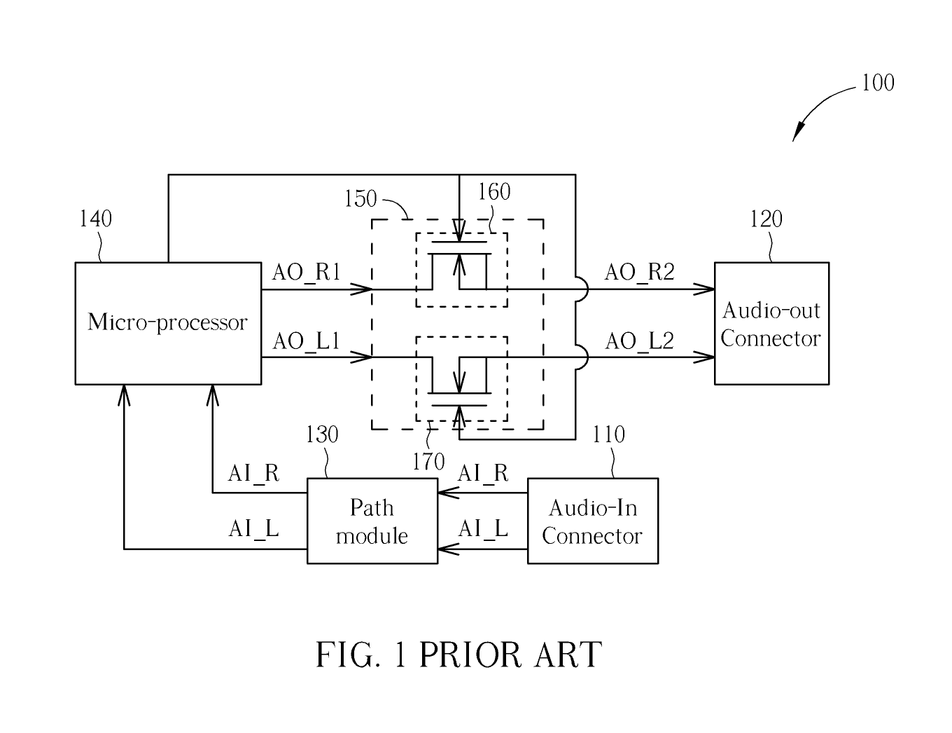

FIG. 2 is a schematic diagram of an audio device according to one embodiment of the present invention.

FIG. 3 is a detailed diagram of the audio device shown in FIG. 2 for handling audio-in/audio-out signals and right audio-in/audio-out signals.

FIG. 4, which illustrates an audio signal inputting and outputting method for the audio device according to descriptions mentioned about FIGS. 2-3 and according to one embodiment of the present invention.

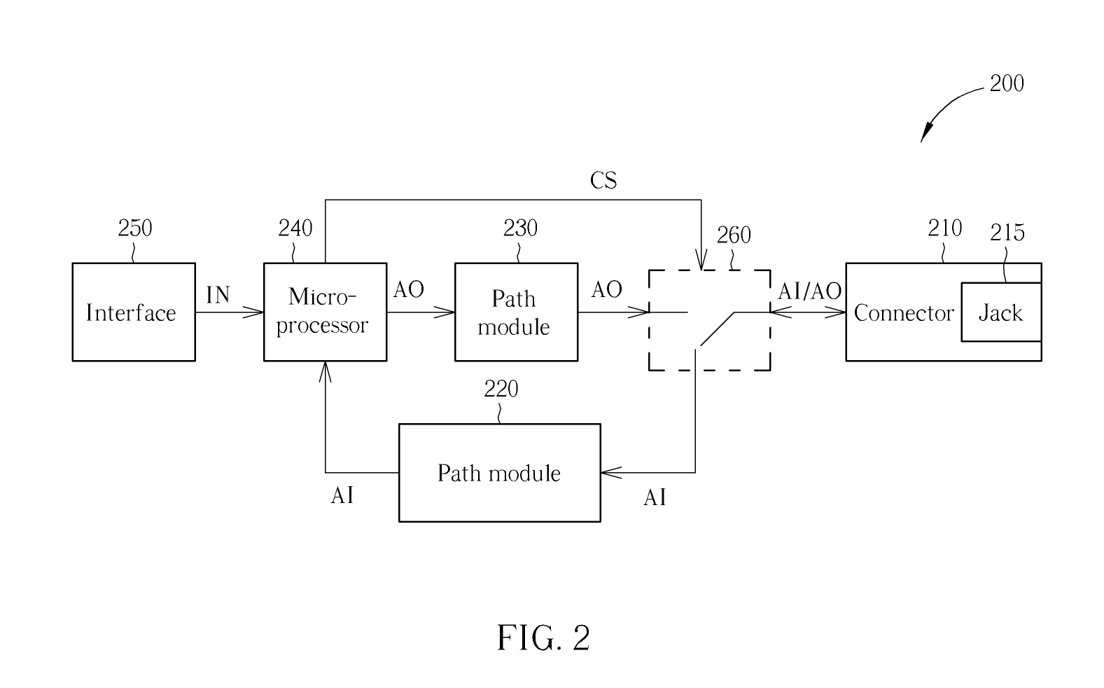

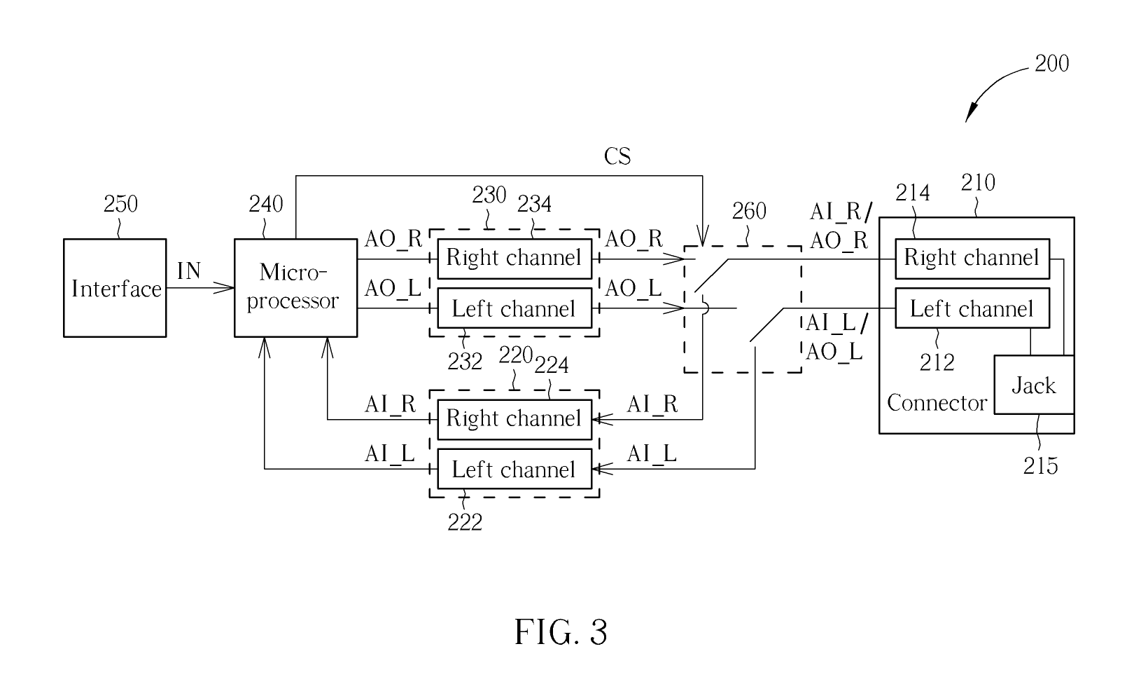

Please refer to FIG. 5 illustrates an audio signal inputting and outputting method for the audio device according to descriptions mentioned in FIGS. 2-3 about different ways for introducing the ignorable delay and according to one embodiment of the present invention.

### DETAILED DESCRIPTION

For relieving from the additional costs in the conventional audio player 100, the present invention discloses an audio device without using redundant connectors for inputting audio-in signals or outputting audio-out signals.

Please refer to FIG. 2, which is a schematic diagram of an audio device 200 according to one embodiment of the present invention. As shown in FIG. 2, the audio device 200 includes at least a connector 210, a multiplexer 260, a path module 220, a micro-processor 240, and a path module 230. The connector 210 is configured to interface with an external device, for inputting an audio-in signal AI generated from the external device, or for outputting an audio-out signal AO generated from the micro-processor 240, where the external device may be a headphone. The format of the audio-in signal AI and the audio-out signal AO may both be analog. The micro-processor 240 is configured to selectively process the audio-in signal AI or to generate the audio-out signal AO. The path module 230 is configured to transmit the audio-out signal AO from the micro-processor 240. The path module 220 is configured to transmit the audio-in signal AI to the micro-processor 240. The multiplexer 260 is configured to selectively transmit the audio-out signal AO from the path module 230 to the connector 210 or transmit the audio-in signal AI from the connector 210 to the path module 220, according to a control signal CS from the micro-processor 240. Therefore, each of the path modules 220, 230 acts as a one-way path, and the path between the multiplexer 260 and the connector 210 (not shown) acts as a two-way path. The multiplexer 260 is also configured to connect the two-way path to one of the two one-way paths (the path modules 220 and 230).

In one embodiment of the present invention, the connector 210 may further include a jack 215 for accommodating a plug of the external device, being used for inputting the audio-in signal AI from the external device or for outputting the audio-out signal AO to the external device.

Operations of the audio device 200 are introduced as follows.

When the audio device 200 is utilized for recording or for storing audios, the audio-in signal AI is received at the connector 210, and the micro-processor 240 generates the control signal CS configured to enable a connection between the connector 210 and the path module 220 at this time by controlling the multiplexer 260, where a connection between connector 210 and the path module 230 is disabled at this time. Therefore, the audio-in signal AI is transmitted through the connector 210, the multiplexer 260 and the path module 220, and is processed in the micro-processor 240 at last.

When the audio device 200 is utilized for playing audios, the micro-processor 240 generates the control signal CS configured to enable the connection between the path module 230 and the connector 210 at this time by controlling the multiplexer 260, then generates the audio-out signal AO, where the connection between the connector 210 and the path module 220 is disabled at this time. Therefore, the audio-out signal AO is transmitted through the micro-processor 240, the path module 230, the multiplexer 260 and the connector 210, and is outputted to the external device currently electrically connected to the connector 210 at last.

As can be observed from the above descriptions and FIG. 2, there is only one connector, i.e. the connector 210, utilized for inputting the audio-in signal AI or for outputting the audio-out signal AO in the audio device 200 by utilizing the multiplexer 260. Besides, the utilization of the multiplexer 260 may introduce an ignorable delay for the micro-processor 240 while generating the audio-out signal AO, where the ignorable delay is just fit to avoid the above-mentioned spikes introduced at the beginning of generating the audio-out signal AO. As a result, the cost introduced by an additional connector and N-type MOSFETs in the conventional audio device is saved with the aid of the multiplexer 260.

The abovementioned ignorable delay may be fulfilled in other ways according to some embodiments of the present invention. In one embodiment of the present invention, the multiplexer 260 may be controlled by the micro-processor 240 to be connected to the path module 220 as a default setting; therefore, when the micro-processor 240 starts outputting the audio-out signal AO, an ignorable delay may be introduced from a transitional duration when the multiplexer 260 switched its connection from the path module 220 to the path module 230 under the control of the micro-processor 240, where the ignorable delay may be a few tens of milliseconds in length. In another embodiment of the present invention, the multiplexer 260 may be controlled by the micro-processor 240 to not be connected to anyone of the path module 220 and the path module 230 as a default setting under the control of the micro-processor 240; therefore, the ignorable delay may also be introduced during the duration when the connection of the multiplexer 260 is transit to the path module 230 under the control of the micro-processor 240.

In some embodiments of the present invention, an interface 250 may be optionally disposed in the audio device 200 for a user of the audio device 200 to decide the purpose of the control signal CS, where the purpose may include inputting the audio-in signal AI and outputting the audio-out signal AO. The interface 250 is configured to receive a user input IN as a command to be received by the micro-processor 240 for deciding the purpose of the control signal CS, and may be a touch panel or a hardware switch. Note that the purpose of the control signal CS may also be determined by the micro-processor 240 automatically, according to a type of the external device electrically connected to the connector 210; for example, when the external device is a headphone, the control signal CS may be set to enable the connection between the path module 230 and the connector 210 for outputting the audio-out signal AO; else, when the external device is a sound collector, the purpose of the control signal CS may be set to enable the connection between the path module 220 and the connector 210 for inputting the audio-in signal AI.

In considerations of left audio-in/audio-out signals and right audio-in/audio-out signals, the audio device 200 may be adapted a bit, but is still capable of saving the costs mentioned above. Please refer to FIG. 3, which is a detailed diagram of the audio device 200 shown in FIG. 2 according to one embodiment of the present invention, for handling audio-in/audio-out signals and right audio-in/audio-out signals. As can be observed in FIG. 3, the connector 210 includes a left channel 212 and a right channel 214; the path module 220 includes a left channel 222 and a right channel 224; and the path module 230 includes a left channel 232 and a right channel 234.

When the micro-processor 240 is configured to receive audios from an external device electrically connected to the connector 210, the micro-processor 240 generates the control signal CS for enabling the connections between the connector 210 and the path module 220, and therefore disabling the connections between the connector 210 and the path module 230 at the same time. Therefore, a left audio-in signal AI_L is transmitted through the left channel 212, the multiplexer 260 and the left channel 222, and is processed in the micro-processor 240; similarly, a right audio-in signal AI_R is transmitted through the right channel 214, the multiplexer 260 and the right channel 224, and is processed in the micro-processor 240.

When the micro-processor 240 is configured to output audios to the external device electrically connected to the connector 210, the micro-processor 240 generates the control signal CS for enabling the connections between the connector 210 and the path module 230 in advance, and therefore disabling the connections between the connector 210 and the path module 220 at the same time. Therefore, a left audio-out signal AO_L is transmitted through the left channel 232, the multiplexer 260 and the left channel 212, and is outputted to the external device via the connector 210; similarly, a right audio-out signal AO_R is transmitted through the right channel 234, the multiplexer 260 and the right channel 24, and is outputted to the external device via the connector 210.

Note that only one connector or one jack is required for inputting or outputting a left audio signal and a right audio signal at the same time, therefore, the abovementioned costs are still saved in the audio device 200 shown in FIG. 3 in comparison to the conventional audio player 100.

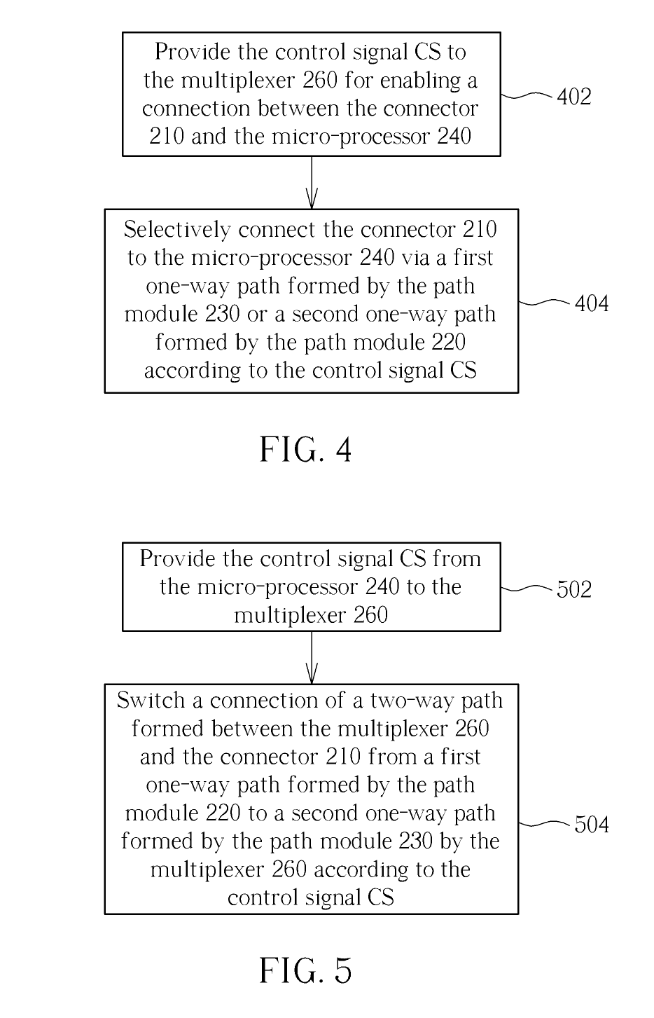

Please refer to FIG. 4, which illustrates an audio signal inputting and outputting method for the audio device according to descriptions mentioned about FIGS. 2-3 and according to one embodiment of the present invention. Steps shown in FIG. 4 include the following:

Step 402: Provide the control signal CS to the multiplexer 260 for enabling a connection between the connector 210 and the micro-processor 240.

Step 404: Selectively connect the connector 210 to the micro-processor 240 via a first one-way path formed by the path module 230 or a second one-way path formed by the path module 220 according to the control signal CS.

Please refer to FIG. 5, which illustrates an audio signal inputting and outputting method for the audio device according to descriptions mentioned in FIGS. 2-3 about different ways for introducing the ignorable delay and according to one embodiment of the present invention. Steps shown in FIG. 5 include the following:

Step 502: Provide the control signal CS from the micro-processor 240 to the multiplexer 260.

Step 504: Switch a connection of a two-way path formed between the multiplexer 260 and the connector 210 from a first one-way path formed by the path module 220 to a second one-way path formed by the path module 230 by the multiplexer 260 according to the control signal CS.

Note that embodiments formed by reasonable combination/permutation of the steps shown in FIGS. 4-5 or by adding limitations mentioned above to the steps shown in FIGS. 4-5 should also be regarded as embodiments of the present invention.

The present invention discloses an audio device for inputting an audio-in signal and outputting an audio-out signal with only one connector, and an audio signal inputting and outputting method implemented on the audio device. With the aid of a multiplexer, not only the cost of a redundant connector can be saved, but the cost of utilizing additional N-type MOSFETs for relieving spikes can also be saved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio device, comprising:
a connector configured to electrically interface with an external device;
a micro-processor configured to selectively process an audio-in signal or to generate an audio-out signal;
a first path module configured to transmit the audio-out signal from the micro-processor;
a second path module configured to transmit the audio-in signal to the micro-processor; and
a multiplexer configured to receive a control signal generated from the micro-processor and selectively transmit the audio-out signal from the first path module to the connector or transmit the audio-in signal from the connector to the second path module in accordance with the control signal from the micro-processor.

2. The audio device of claim 1, wherein the micro-processor is further configured to generate the control signal according to a user input.

3. The audio device of claim 2 further comprising a touch panel for receiving the user input.

4. The audio device of claim 2 further comprising a hardware switch for receiving the user input.

5. The audio device of claim 1, wherein the connector comprises a jack configured to accommodate a plug of the external device to transmit both the audio-in signal and the audio-out signal.

6. The audio device of claim 1, wherein the connector comprises a first left channel and a first right channel, the first left channel and the first right channel are respectively configured to input a left audio-in signal and a right audio-in signal of the audio-in signal generated from the external device, and to output a left audio-out signal and a right audio-out signal of the audio-out signal generated from the micro-processor.

7. The audio device of claim 1, wherein the first path module comprises a second left channel and a second right channel, the second left channel is configured to transmit the left audio-out signal from the micro-processor to the multiplexer, and the second right channel is configured to transmitting the right audio-out signal from the micro-processor to the multiplexer.

8. The audio device of claim 1, wherein the second path module comprises a third left channel and a third right channel, the third left channel is configured to transmit the left audio-in signal from the multiplexer to the micro-processor, and the third right channel is configured to transmit the right audio-in signal from the multiplexer to the micro-processor.

9. The audio device of claim 1, wherein the multiplexer configured to selectively transmit the audio-out signal from the first path module to the connector or transmit the audio-in signal from the connector to the second path module, is by ways of selectively connecting the first path module and the connector or connecting the second path module and the connector.

10. The audio device of claim 9, wherein the multiplexer configured to connect the second path module and the connector before receiving the control signal from the micro-processor.

11. An audio signal inputting and outputting method for an audio device, the audio device comprises a multiplexer connected to a connector through a two-way path and selectively connected to a micro-processor through a first one-way path or a second one-way path, the method comprising:
providing a control signal to the multiplexer for enabling a connection between the connector and the micro-processor; and
selectively connecting the connector and the micro-processor via the first one-way path or the second one-way path according to the control signal.

12. The audio signal inputting and outputting method of claim 11, wherein the step of selectively connecting the connector and the micro-processor via the first one-way path or the second one-way path according to the control signal comprises:
transmitting an audio-out signal from the micro-processor through the first one-way path to the connector.

13. The audio inputting and outputting method of claim 12, wherein the control signal indicates a purpose of inputting the audio-in signal or outputting the audio-out signal.

14. The audio signal inputting and outputting method of claim 11, wherein the step of selectively connecting the connector and the micro-processor via the first one-way path or the second one-way path according to the control signal comprises:
transmitting an audio-in signal from the connector to the micro-processor through the second one-way path.

15. The audio inputting and outputting method of claim 14, wherein the control signal indicates a purpose of inputting the audio-in signal or outputting the audio-out signal.

16. An audio signal inputting and outputting method for an audio device, the audio device comprises a two-way path utilized for connecting a connector to a multiplexer, a first one-way path and a second one-way path utilized for connecting a micro-processor to the multiplexer, the method comprising:
providing a control signal from the micro-processor to the multiplexer; and
switching a connection of the two-way path from the first one-way path to the second one-way path by the multiplexer according to the control signal.

17. The audio signal inputting and outputting method of claim 16, wherein the first one-way path is used for transmitting an audio-in signal from the connector to the micro-processor.

18. The audio signal inputting and outputting method of claim 16, wherein the second one-way path is used for transmitting an audio-out signal from the micro-processor to the connector.

19. The audio signal inputting and outputting method of claim 16 further comprises:
connecting the two-way path to the second one-way path before performing the step of providing the control signal from the micro-processor to the multiplexer.
